(19) United States
(12) Patent Application Publication
(10) Pub. No.: US 2008/0100607 A1
(43) Pub. Date: May 1, 2008

(54) Plasma display, and driving device and method thereof

(76) Inventor: Joon-Yeon Kim, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/904,201

(22) Filed: Sep. 26, 2007

(30) Foreign Application Priority Data
Oct. 31, 2006 (KR) 10-2006-0106571

(51) Int. Cl. G09G 5/00; G09G 3/28

(52) U.S. Cl. 345/211; 345/60

(57) ABSTRACT

A driver circuit for a plasma display panel is disclosed. The circuit drives the panel using low supply voltage to reduce cost. The circuit sequentially charges and discharges capacitors to provide signals to the panel during reset, address, and sustain periods.

### CROSS-REFERENCE TO RELATED APPLICATION

This application claims priority to Korean patent application No. 10-2006-0106571 filed in the Korean Intellectual Property Office on Oct. 31, 2006, and all the benefits accruing therefrom under 35 U.S.C. §119. The contents of the Korean patent application are incorporated herein by reference in their entirety.

### BACKGROUND OF THE INVENTION

1. Field

The present invention relates to a plasma display and a driving apparatus and method thereof.

2. Description of the Related Technology

A plasma display panel (PDP) is a flat panel display that uses plasma generated by gas discharge to display characters or images. It includes, depending on its size, more than several scores to millions of pixels arranged in a matrix pattern.

One frame of the plasma display is divided into a plurality of subfields respectively having weights, and grayscales are expressed by a combination of the weights of the subfields that are used to perform a display operation. Turn-on/turn-off cells (i.e., cells to be turned on or off) are selected during an address period of each subfield, and a sustain discharge operation is performed on the turn-on cells so as to display an image during a sustain period.

In particular, since a high level voltage and a low level voltage are alternately applied to an electrode on which the sustain discharge operation is performed during the sustain period, a transistor for applying both the high and low voltages is required. Accordingly, the cost of a sustain discharge circuit is increased due to the transistor.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is a plasma display including a first electrode, a second electrode configured to perform a display operation in cooperation with the first electrode, a first transistor coupled to the first electrode, a second transistor coupled to the first electrode, a first capacitor configured to be charged with a first voltage and coupled to the first transistor, a second capacitor configured to be charged with a second voltage and coupled between the first capacitor and a first node, a third capacitor configured to be charged with a third voltage and coupled to the first node, a fourth capacitor configured to be charged with a fourth voltage and coupled between the third capacitor and the second transistor, a third transistor coupled between a first power source for supplying a fifth voltage and the first node, a fourth transistor coupled between a second power source for supplying a sixth voltage and the first node, the sixth voltage being less than the fifth voltage, a first path coupled between a node of the first and second capacitors and the first transistor configured to change a voltage at the first electrode, a second path coupled between a node of the third and fourth capacitors and the second transistor configured to change the voltage at the first electrode, and a reset driving circuit that is coupled to the second electrode and configured to gradually change a voltage at the second electrode during a reset period.

Another aspect is a method of driving a plasma display including a plurality of first and second electrodes to perform a display operation, the method including during a reset period, gradually varying a voltage at the plurality of first electrodes while applying a first voltage to the plurality of second electrodes, during an address period, sequentially applying a scan pulse to the plurality of second electrodes, during a sustain period, increasing a voltage at the plurality of second electrodes through a first capacitor coupled between a first node and the plurality of second electrodes while supplying a second voltage to the first node, and further increasing the voltage at the plurality of second electrodes through a second capacitor coupled between the first node and the plurality of second electrodes while supplying the second voltage to the first node. The method also includes further increasing the voltage at the plurality of second electrodes through the second capacitor while supplying a third voltage that is higher than the second voltage to the first node, decreasing the voltage at the plurality of second electrodes through the second capacitor while supplying the third voltage to the first node, further decreasing the voltage at the plurality of second electrodes through the first capacitor while supplying the third voltage to the first node, and further decreasing the voltage at the plurality of second electrodes through the first capacitor while supplying the second voltage to the first node.

Another aspect is a driver of a plasma display including a plurality of first electrodes and a plurality of second electrodes, the driver further including a scan integrated circuit including first and second input terminals and a plurality of first output terminals respectively coupled to the plurality of second electrodes, the scan integrated circuit configured to apply voltages at the first and second input terminals to the corresponding second electrode during an address period, a first capacitor charged with a first voltage and coupled between the first input terminals, a second capacitor charged with a second voltage and coupled between the first capacitor and a first node, a third capacitor charged with a third voltage and coupled to the first node, a fourth capacitor charged with a fourth voltage and coupled between the third capacitor and the second input terminal, a first path coupled between a node of the first and second capacitors and the first input terminal of the scan integrated circuit, the first path configured to change a voltage at the plurality of first electrodes, a second path coupled between a node of the third and fourth capacitors and the second input terminal of the scan integrated circuit, the second path configured to change the voltage at the plurality of first electrodes, a first switching means configured to selectively apply a fifth voltage and a sixth voltage to the first node, the sixth voltage being less than the fifth voltage, and a reset driving circuit coupled to the plurality of first electrodes configured to gradually change a voltage at the plurality of second electrodes during a reset period.

### BRIEF DESCRIPTION OF THE DRAWINGS

FIG. 1 is a diagram representing a plasma display according to one embodiment.

FIG. 2 is a diagram representing driving waveforms according to an embodiment.

FIG. 3 is a diagram representing a sustain discharge driving circuit 410 of the scan electrode driver 400 for generating the driving waveform shown in FIG. 2.

FIG. 4 is a signal timing diagram of the sustain discharge driving circuit 410 for generating the driving waveform shown in FIG. 2.

FIG. 5A to FIG. 5H respectively are diagrams of operations of the sustain discharge driving circuit 410 shown in FIG. 3 according to the signal timing shown in FIG. 4.

FIG. 6A to FIG. 6C respectively are diagrams of the driving waveforms of the plasma display according to other embodiments.

FIG. 7 is a diagram representing a driving circuit 510 coupled to the X electrode.

FIG. 8 is a diagram representing driving waveforms of the plasma display according to another embodiment.

FIG. 9A and FIG. 9B respectively are diagrams representing an operation of the driving circuit 510 for generating the reset waveform shown in FIG. 8.

FIG. 10 to FIG. 12 respectively are diagrams representing driving waveforms of the plasma display according to additional embodiments.

### DETAILED DESCRIPTION OF CERTAIN INVENTIVE EMBODIMENTS

In the following detailed description, certain embodiments have been shown and described, simply by way of illustration. As those skilled in the art would realize, the described embodiments may be modified in various different ways, without departing from the spirit or scope of the present invention. Accordingly, the drawings and description are to be regarded as illustrative in nature and not restrictive.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

When it is described in the specification that a voltage is maintained, it should not be understood to strictly imply that the voltage is maintained exactly at a value. To the contrary, even if a voltage difference between two points varies, the voltage difference is expressed to be maintained at a value in the case that the variance is within a range allowed in design constraints or in the case that the variance is caused due to a parasitic component that may be disregarded by a person of ordinary skill in the art. In addition, since threshold voltages of semiconductor elements (e.g., a transistor and a diode) are very low compared to a discharge voltage, they are considered to be 0V.

A plasma display according to one embodiment, and a driving apparatus and a driving method thereof, will now be described with reference to the figures.

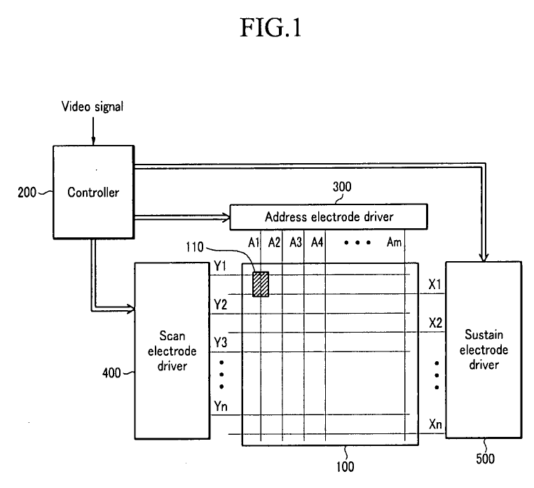

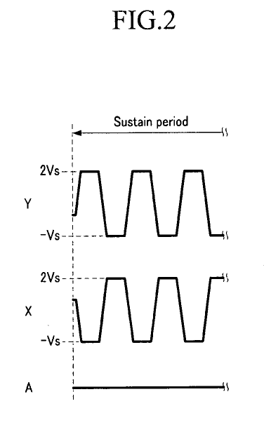

FIG. 1 shows a diagram representing a plasma display according to one embodiment, and FIG. 2 shows a diagram representing driving waveforms according to an embodiment. In FIG. 2, for better understanding and ease of description, a description will be given based on a cell formed by one A electrode, one Y electrode, and one X electrode, and the A, Y, and X electrodes are respectively denoted by A, Y, and X.

As shown in FIG. 1, a plasma display according to one embodiment of includes a plasma display panel (PDP) 100, a controller 200, an address electrode driver 300, a scan electrode driver 400, and a sustain electrode driver 500.

The PDP 100 includes a plurality of address electrodes A1 to Am (hereinafter referred to as “A electrodes”) extending in a column direction, and a plurality of sustain and scan electrodes X1 to Xn and Y1-Yn (hereinafter respectively referred to as “X electrodes” and “Y electrodes”) extending in a row direction by pairs. The X electrodes X1 to Xn are formed in correspondence to the Y electrodes Y1 to Yn, and a display operation is performed by the X and Y electrodes in the sustain period. The Y and X electrodes Y1 to Yn and X1 to Xn are arranged perpendicular to the A electrodes A1 to Am. Here, a discharge space formed at an area where the address electrodes A1 to Am cross the sustain and scan electrodes X1 to Xn and Y1 to Yn forms a discharge cell 110. The configuration of the PDP 100 shown in FIG. 1 is an example, and another configuration may be used.

The controller 200 outputs X, Y, and A electrode driving control signals after receiving an image signal. In addition, the controller 200 operates on each frame divided into a plurality of subfields having respective weight values, and each subfield includes an address period and a sustain period.

The address electrode driver 300 applies a driving voltage to the A electrodes A1 to Am according to the driving control signal from the controller 200.

The scan electrode driver 400 applies the driving voltage to the Y electrodes Y1 to Yn according to the driving control signal from the controller 200.

The sustain electrode driver 500 applies the driving voltage to the X electrodes X1 to Xn according to the driving control signal from the controller 200.

In further detail, as shown in FIG. 2, during the sustain period of each subfield, while the address electrode driver 300 applies a reference voltage (0V in FIG. 2) to the A electrode A, the scan electrode driver 400 applies a sustain pulse alternately having a high level voltage 2Vs and a low level voltage −Vs to the Y electrode Y a number of times corresponding to a weight value of the corresponding subfield. In addition, the sustain electrode driver 500 applies the sustain pulse to the X and Y electrodes X and Y, and the sustain pulses applied to the X and Y electrodes X and Y have opposite phases. Accordingly, a voltage difference between the respective Y electrodes and X electrodes alternately has a 3Vs voltage and a −3Vs voltage, and a sustain discharge is generated in a turn-on cell (i.e., a cell to be turned on).

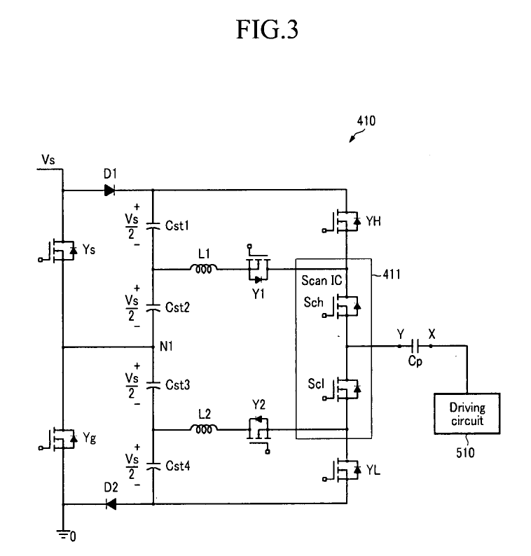

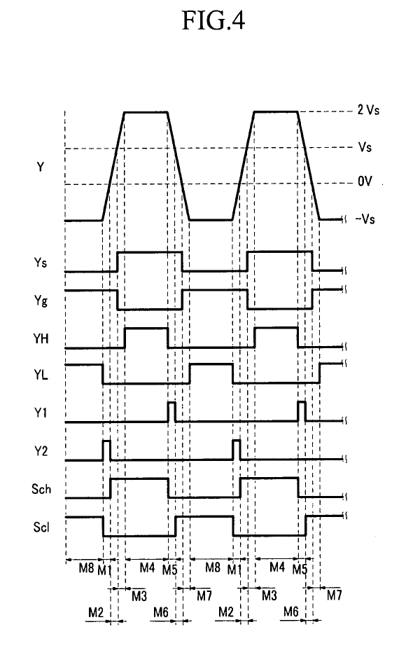

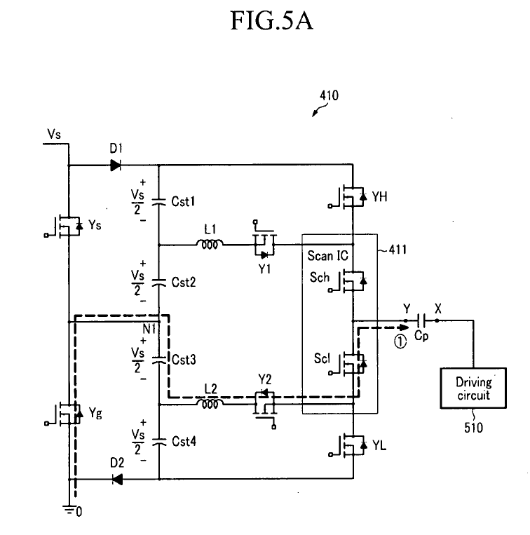

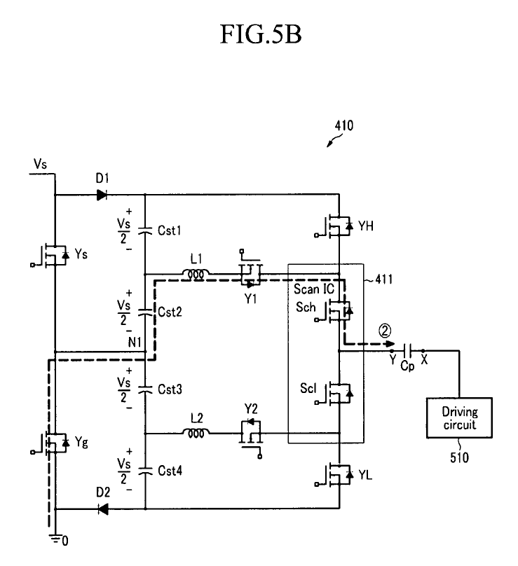

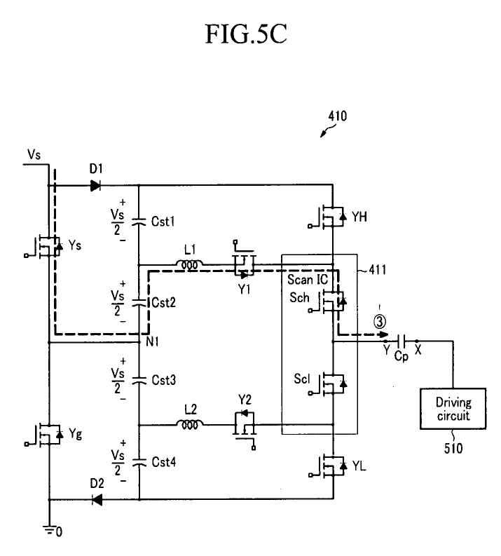

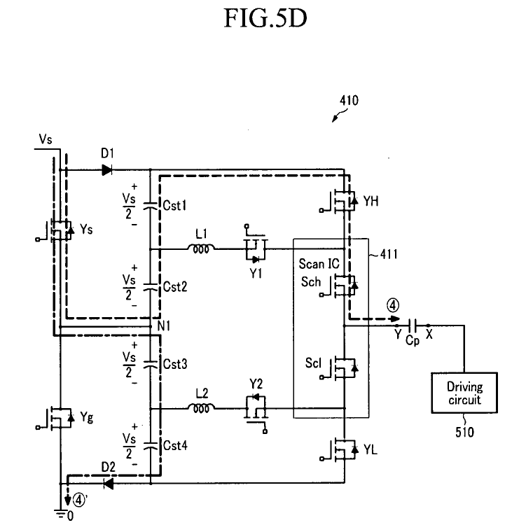

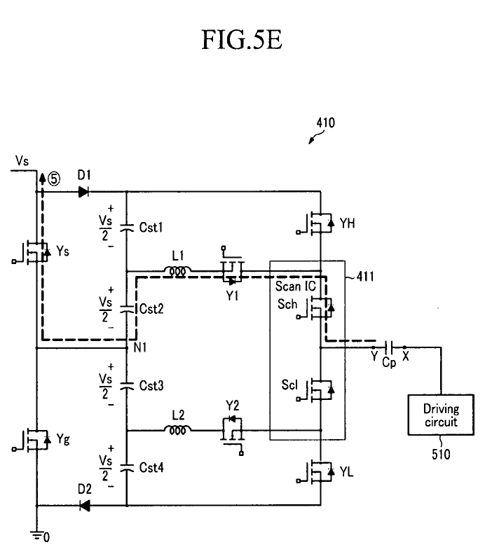

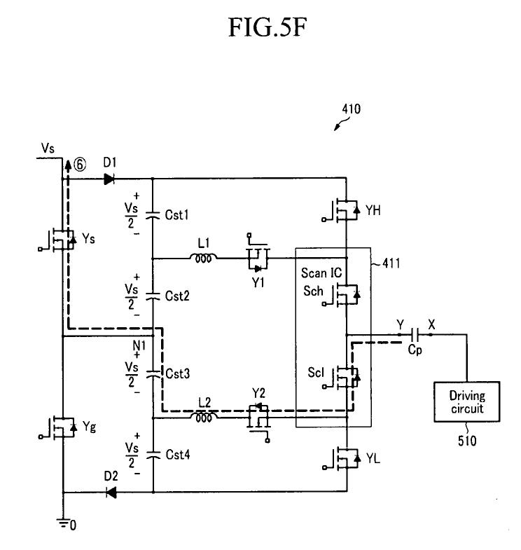

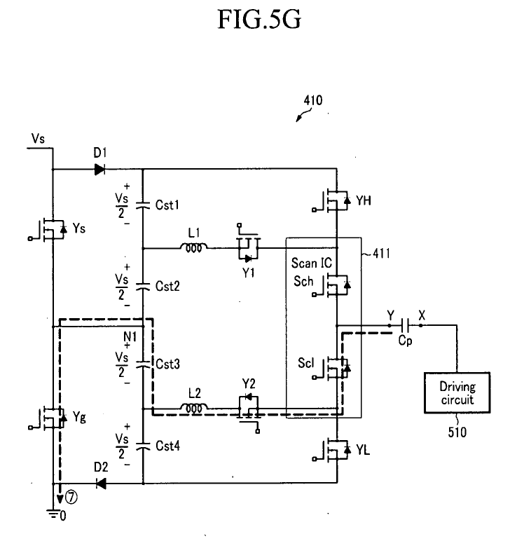

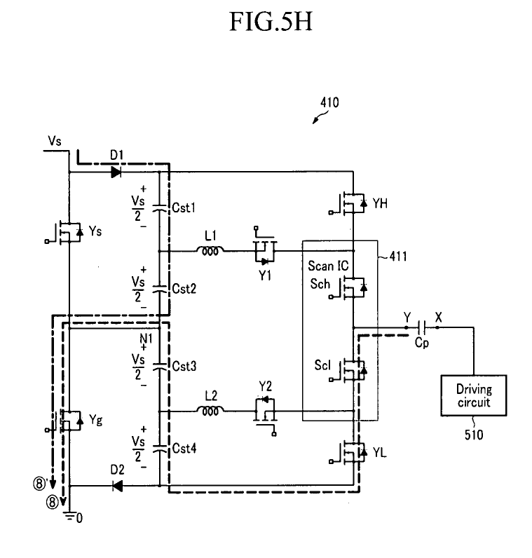

A sustain discharge driving circuit for supplying the sustain pulse shown in FIG. 2 will now be described with reference to FIG. 3, FIG. 4, and FIG. 5A to FIG. 5H.

FIG. 3 shows a diagram representing a sustain discharge driving circuit 410 of the scan electrode driver 400 for generating the driving waveform shown in FIG. 2. In FIG. 3, for better understanding and ease of description, only the sustain discharge driving circuit 410 connected to the plurality of Y electrodes Y1-Yn is illustrated, and the sustain discharge driving circuit 410 may be formed in the scan electrode driver 400 shown in FIG. 1. In addition, in the sustain discharge driving circuit 410, for better understanding and ease of description, one X electrode X and one Y electrode Y are illustrated, and a capacitance formed by the X electrode X and the Y electrode Y is illustrated as a panel capacitor Cp.

As shown in FIG. 3, the sustain discharge driving circuit 410 includes transistors Ys, Yg, Y1, Y2, YH, YL, Sch, and Sc1, capacitors Cst1, Cst2, Cst3, and Cst4, inductors L1 and L2, diodes D1 and D2, and a scan integrated circuit (hereinafter referred to as a “scan IC”) 411. In FIG. 3, the transistors Ys, Yg, Y1, Y2, YH, YL, Sch, and Sc1 are illustrated as n-channel field effect transistors (particularly as n-channel metal oxide semiconductor (NMOS) transistors), and a body diode may be formed from a source to a drain in the transistors Ys, Yg, Y1, Y2, YH, YL, Sch, and Sc1. Rather than using the NMOS transistor, other transistors that can perform a similar function may be used for the transistors Ys, Yg, Y1, Y2, YH, YL, Sch, and Sc1. In addition, the transistors Ys, Yg, Y1, Y2, YH, YL, Sch, and Sc1 are respectively illustrated as one transistor in FIG. 3, and the respective transistors Ys, Yg, Y1, Y2, YH, YL, Sch, and Sc1 may include a plurality of transistors coupled in parallel to each other.

As shown in FIG. 3, the scan IC 411 includes a first input terminal and a second input terminal, and an output terminal thereof is coupled to the Y electrode Y of the panel capacitor Cp. The scan IC 411 selectively applies a voltage at the first input terminal and a voltage at the second input terminal to the Y electrode Y to select a turn-on cell during the address period. In FIG. 3, while it is illustrated that one Y electrode Y is coupled to the scan IC 411, the scan IC 411 may include a plurality of output terminals. That is, the plurality of Y electrodes Y1 to Yn may be coupled to the plurality of output terminals of the scan IC 411. In this case, when the number of output terminals of the scan IC 411 is less than the number of the Y electrodes Y1 to Yn, the plurality of scan ICs 411 may be used. The scan IC 411 includes transistors Sch and Sc1. A source of the transistor Sch and a drain of the transistor Sc1 are respectively coupled to the Y electrode of the panel capacitor Cp, a drain of the transistor Sch is coupled to the first input terminal of the scan IC 411, and a source of the transistor Sc1 is coupled to the second input terminal of the scan IC 411. The drain of the transistor Sch is coupled to a source of the transistor YH, and the source of the transistor Sc1 is coupled to a drain of the transistor YL. In addition, two capacitors Cst1 and Cst2 are coupled in series between a drain of the transistor YH and a node N1, and two capacitors Cst3 and Cst4 are coupled in series between a source of the transistor YL and the node N1. The inductor L1 and the transistor Y1 are coupled in series between a node of the capacitors Cst1 and Cst2 and the first input terminal of the scan IC 411, and the inductor L2 and the transistor Y2 are coupled in series between a node of the capacitors Cst3 and Cst4 and the second input terminal of the scan IC 411. In this case, positions of the inductor L1 and the transistor Y1 may be switched, and positions of the inductor L2 and transistor Y2 may also be switched.

A drain of the transistor Ys is coupled to a power source Vs for supplying a Vs voltage corresponding to ⅓ of a difference 3Vs between a high level voltage 2Vs and a low level voltage −Vs of the sustain pulse, and a source of the transistor Ys is coupled to the node N1. In addition, a source of the transistor Yg is coupled to a ground terminal for supplying a 0V voltage corresponding to the difference 3Vs between the high level voltage 2Vs and the low level voltage −Vs of the sustain pulse, and a drain of the transistor Yg is coupled to the node N1. In this case, the transistors Ys and Yg operate as switching units for selectively applying the Vs voltage or the 0V voltage to the node N1.

An anode of the diode D1 is coupled to a power source Vs, and a cathode thereof is coupled to the capacitor Cst1. In addition, a cathode of the diode D2 is coupled to the ground terminal 0, and an anode thereof is coupled to the capacitor Cst4. In this case, the diode D1 forms a charging path for respectively charging the capacitors Cst1 and Cst2 with a Vs/2 voltage when the transistor Yg is turned on, and the capacitors Cst1 and Cst2 are charged with the Vs/2 voltage through the charging path. In addition, the diode D2 forms a charging path for charging the capacitors Cst3 and Cst4 with the Vs/2 voltage when the transistor Ys is turned on, and the capacitors Cst3 and Cst4 are respectively charged with the Vs/2 voltage. Rather than using the diodes D1 and D2, another element (e.g., a transistor) for forming the charging path may be used.

An operation of the sustain discharge driving circuit 410 shown in FIG. 3 will be described with reference to FIG. 4 and FIG. 5A to FIG. 5H.

FIG. 4 shows a signal timing diagram of the sustain discharge driving circuit 410 for generating the driving waveform shown in FIG. 2, and FIG. 5A to FIG. 5H respectively show diagrams of operations of the sustain discharge driving circuit 410 shown in FIG. 3 according to the signal timing shown in FIG. 4. It is assumed that the transistors Yg, YL, and Sc1 are turned on and the −Vs voltage is applied to the Y electrode before starting a mode 1 M1.

As shown in FIG. 4 and FIG. 5A, at the mode 1 M1, the transistor Y2 is turned on, the transistor YL is turned off, and a resonance is generated through a path [symbol] of a ground terminal 0, the body diode of the transistor Yg, the capacitor Cst3, the inductor L2, the transistor Y2, the body diode of the transistor Sc1, and the Y electrode Y of the panel capacitor Cp. Thereby, energy charged in the capacitor Cst3 is provided to the Y electrode Y through the inductor L2, and a voltage at the Y electrode Y is increased from the −Vs voltage to the 0V voltage. In this case, since the 0V voltage is applied to the source of the transistor Ys, the Vs voltage is applied between the drain and the source of the transistor Ys. That is, the transistor having the Vs voltage may be used as the transistor Ys.

Subsequently, at a mode 2 M2, the transistors Y1 and Sch are turned on, the transistors Y2 and Sc1 are turned off, and as shown in FIG. 5B, the resonance is generated through a path [symbol] of the ground terminal 0, the body diode of the transistor Yg, the capacitor Cst2, the inductor L1, the body diode of the transistor Y1, the transistor Sch, and the Y electrode Y of the panel capacitor Cp. Thereby, energy charged in the capacitor Cst2 is provided to the Y electrode Y through the inductor L1, and the voltage at the Y electrode Y is increased from the 0V voltage to the Vs voltage.

At a mode 3 M3, the transistor Ys is turned on, the transistor Yg is turned off, and as shown in FIG. 5C, the resonance is generated through a path [symbol] of the power source Vs, the transistor Ys, the capacitor Cst2, the inductor L1, the body diode of the transistor Y1, the transistor Sch, and the Y electrode Y of the panel capacitor Cp. Thereby, the energy charged in the capacitor Cst2 is provided to the Y electrode through the inductor L1, and the voltage at the Y electrode Y is increased from the Vs voltage to the 2Vs voltage. In this case, since the Vs voltage is applied to the drain of the transistor Yg, the Vs voltage is applied between the drain and the source of the transistor Yg. That is, the transistor having the Vs voltage may be used as the transistor Yg.

Subsequently, at a mode 4 M4, the transistor YH is turned on, the transistor Y1 is turned off, and as shown in FIG. 5D, the 2Vs voltage is applied to the Y electrode through a path [symbol] of the power source Vs, the transistor Yg, the capacitors Cst2 and Cst1, the transistors YH and Sch, and the Y electrode of the panel capacitor Cp. In addition, as shown in FIG. 5D, the Vs/2 voltage is respectively charged in the capacitors Cst3 and Cst4 through a path [symbol] of the power source Vs, the transistor Yg, the capacitors Cst3 and Cst4, the diode D2, and the ground terminal 0. In this case, since a source voltage of the transistor Sch is the Vs voltage and the 0V voltage is applied to the source of the transistor YL, and the 2Vs voltage is applied between the drain of the transistor Sc1 and the source of the transistor YL. That is, the transistor having the Vs voltage may be used as the respective transistors Sc1 and YL. In addition, since a source voltage of the transistor Y1 is a 3Vs/2 voltage and a drain voltage of the transistor Y1 is the Vs voltage, the Vs/2 voltage is applied between the drain and the source of the transistor Y1. That is, the transistor having the Vs/2 voltage may be used as the transistor Y1.

At a mode 5 M5, the transistor Y1 is turned on, the transistor YH is turned off, and as shown in FIG. 5E, the resonance is generated through a path [symbol] of the Y electrode of the panel capacitor Cp, the body diode of the transistor Sch, the transistor Y1, the inductor L1, the capacitor Cst2, the body diode of the transistor Ys, and the power source Vs. Thereby, while energy stored in the panel capacitor Cp is recovered to the power source Vs through the inductor L1, the voltage at the Y electrode Y is reduced from the 2Vs voltage to the Vs voltage.

At a mode 6 M6, the transistors Y2 and Sc1 and the transistors Y1 and Sch are turned off, and as shown in FIG. 5F, the resonance is generated through a path [symbol] of the Y electrode Y of the panel capacitor Cp, the transistor Sc1, the body diode of the transistor Y2, the inductor L2, the capacitor Cst3, the body diode of the transistor Ys, and the power source Vs. Thereby, the energy stored in the panel capacitor Cp is recovered to the power source Vs through the inductor L2, and the voltage at the Y electrode Y is reduced from the Vs voltage to the 0V voltage.

At a mode 7 M7, since the transistor Yg is turned on, the transistor Ys is turned off, and as shown in FIG. 5G, the resonance is generated through a path [symbol] of the Y electrode of the panel capacitor Cp, the transistor Sc1, the body diode of the transistor Y2, the inductor L2, the capacitor Cst3, the transistor Yg, and the ground terminal 0. Thereby, the energy stored in the panel capacitor Cp is recovered to the ground terminal 0 through the inductor L2, and the voltage at the Y electrode Y is reduced from the 0V voltage to the −Vs voltage.

At a mode 8 M8, the transistor YL is turned on, the transistor Y2 is turned off, and as shown in FIG. 5H, the −Vs voltage is applied to the Y electrode Y through a path [symbol] of the Y electrode Y of the panel capacitor Cp, the transistors Sc1 and YL, the capacitors Cst4 and Cst3, the transistor Yg, and the ground terminal 0. In addition, as shown in FIG. 5H, the Vs/2 voltage is respectively charged in the capacitors Cst1 and Cst2 through a path [symbol] of the power source Vs, the diode D1, the capacitors Cst1 and Cst2, the transistor Yg, and the ground terminal 0. In this case, since a drain voltage of the transistor YH is the Vs voltage and a source voltage of the transistor Sch is the −Vs voltage, the 2Vs voltage is applied between the source of the transistor Sch and the drain of the transistor YH. That is, the transistor having the Vs voltage may be used as the respective transistors Sch and YH. In addition, since a drain voltage of the transistor Y2 is the −Vs/2 voltage and a source voltage of the transistor Y2 is the −Vs voltage, the Vs/2 voltage is applied between the drain and the source of the transistor Y2. That is, the transistor having the Vs/2 voltage may be used as the transistor Y2.

As described above, the transistor having the Vs voltage (i.e., ⅓ of a difference 3Vs between the high level voltage 2Vs of the sustain pulse and the low level voltage −Vs) may be used as the transistors Sch, Sc1, Ys, Yg, YH, and YL, and the transistor having the Vs/2 voltage (i.e., ⅙ of the difference 3Vs between the high level voltage 2Vs of the sustain pulse and the low level voltage −Vs) may be used as the transistors Y1 and Y2. In addition, since the mode 1 to mode 8 M1 to M8 are performed the number of times corresponding to a weight value of the corresponding subfield during the sustain period, the 2Vs voltage and the −Vs voltage are alternately applied to the Y electrode.

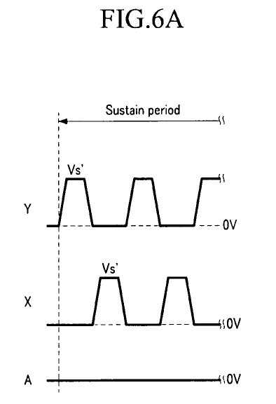

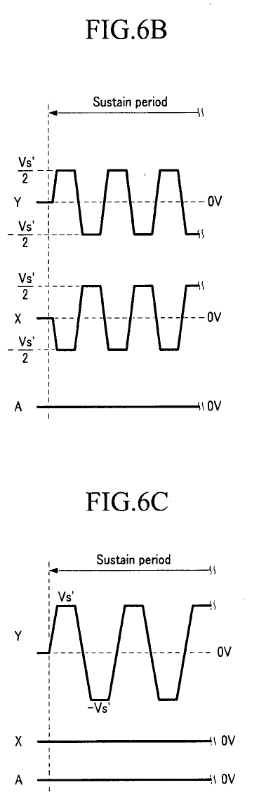

The generation of the driving waveform according to some embodiments has been described with reference to FIG. 5A to FIG. 5H. In the driving waveform shown in FIG. 2, the voltage difference between the Y electrode and the X electrode alternately has the 3Vs voltage and the −3Vs voltage. In this case, when a voltage size of 3Vs is the same as a voltage size of Vs′, driving waveforms shown in FIG. 6A to FIG. 6C may be applied.

FIG. 6A to FIG. 6C respectively show diagrams of the driving waveforms of the plasma display according to other embodiments. In FIG. 6A to FIG. 6C, for better understanding and ease of description, a description will be given based on a cell formed by one A electrode, one Y electrode, and one X electrode, and the A, Y, and X electrodes are respectively denoted by A, Y, and X.

As shown in FIG. 6A, during the sustain period, the scan electrode driver 400 may apply the sustain pulse alternately having a high level voltage Vs′ and a low level voltage 0V to the Y electrode Y a number of times corresponding to the weight value of the corresponding subfield, and the sustain electrode driver 500 may apply the sustain pulse to the X electrode X with an opposite phase of the sustain pulse applied to the Y electrode Y. As shown in FIG. 6B, the scan electrode driver 400 may apply the sustain pulse alternately having a high level voltage Vs′/2 and a low level voltage −Vs′/2 to the Y electrode Y the number of times corresponding to the weight value of the corresponding subfield, and the sustain electrode driver 500 may apply the sustain pulse to the X electrode X with an opposite phase of the sustain pulse applied to the Y electrode Y. Accordingly, the voltage difference between the Y electrode Y and the X electrode X alternately has a Vs′ voltage and a −Vs′ voltage, and therefore a sustain discharge is generated in the turn-on discharge cell a predetermined number of times.

In addition, differing from the second and third exemplary embodiments of the present invention, the sustain pulse may be applied to one of the X electrode X and the Y electrode Y. That is, as shown in FIG. 6C, during the sustain period, while the 0V voltage is applied to the X electrode X, the sustain pulse alternately having the Vs′ voltage and the −Vs′ voltage may be applied to the Y electrode Y. Accordingly, the voltage difference between the Y electrode Y and the X electrode X alternately has the Vs′ voltage and the −Vs′ voltage, and therefore the sustain discharge may be applied in the turn-on discharge cell a predetermined number of times.

In addition, the sustain discharge driving circuit 410 shown in FIG. 3 may generate the driving waveform according to other exemplary embodiments. In further detail, in the sustain discharge driving circuit 410 shown in FIG. 3, when the drain of the transistor Ys is coupled to a power source 2Vs′/3 for supplying a 2Vs′/3 voltage and the source of the transistor Ys is coupled to a power source Vs′/3 for supplying a Vs′/3 voltage, the sustain pulse alternately having the Vs′ voltage and the 0V voltage may be applied to the Y electrode through the paths shown in FIG. 5A to FIG. 5H. In addition, in the sustain discharge driving circuit 410 shown in FIG. 3, when the drain of the transistor Ys is coupled to a power source Vs′/6 for supplying a Vs′/6 voltage and the source of the transistor Ys is coupled to a power source −Vs′/6 for supplying a −Vs′/6 voltage, the sustain pulse alternately having the Vs′/2 voltage and the −Vs′/2 voltage may be applied to the Y electrode through the paths shown in FIG. 5A to FIG. 5H. In addition, in the sustain discharge driving circuit 410 shown in FIG. 3, when the drain of the transistor Ys is coupled to the power source Vs′/3 for supplying the Vs′/3 voltage and the source of the transistor Yg is coupled to a power source −Vs′/3 for supplying a −Vs′/3 voltage, the sustain pulse alternately having the Vs′ voltage and the −Vs′ voltage may be applied to the Y electrode through the paths shown in FIG. 5A to FIG. 5H. In this case, the 0V voltage is applied to the X electrode.

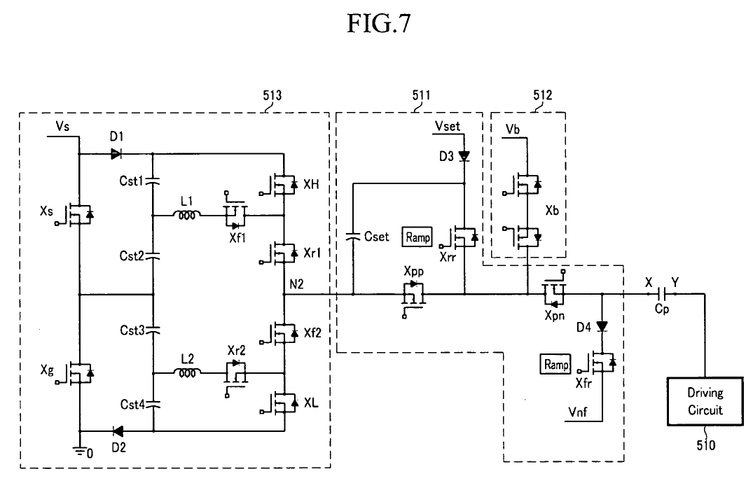

Generally, during the reset period, a gradually increasing voltage waveform and a gradually decreasing voltage waveform are used to initialize the discharge cell. However, in the driving circuit shown in FIG. 5, since the scan IC 411 is used as a switch for applying the sustain pulse, it is difficult to form a circuit element for generating the gradually increasing voltage waveform and the gradually decreasing waveform in the scan electrode driver 400. Accordingly, it is required to provide the circuit element for generating the gradually increasing voltage waveform and the gradually decreasing waveform in the sustain electrode driver 500. FIG. 7 shows a diagram representing a driving circuit coupled to the X electrode and a driving circuit 510.

As shown in FIG. 7, the driving circuit coupled to the Y electrode 510 includes a reset driving circuit 511, an address driving circuit 512, and a sustain discharge driving circuit 513.

The reset driving circuit 511 includes transistors Xrr, Xfr, Xpp, and Xpn, a capacitor Cset, and diodes D3 and D4.

The transistor Xrr includes a drain coupled to a power source Vset for supplying a Vset voltage and a source coupled to the X electrode X. The power source Vset includes a first terminal coupled to the drain of the transistor Xrr and a second terminal coupled to a source of the transistor Xpp. The Vset voltage is charged in the capacitor Cset. In addition, a drain of the transistor Xpp is coupled to the source of the transistor Xrr. In this case, the diode D3 is coupled in an opposite direction of a body diode of the transistor Xrr to interrupt a current path caused by the body diode of the transistor Xrr. The transistor Xpn includes a drain coupled to a node of the drain of the transistor Xpp and the source of the transistor Xrr and a source coupled to the X electrode X. In addition, the transistor Xfr includes a source coupled to a power source Vnf for supplying a Vnf voltage and a drain coupled to the X electrode X. In this case, the diode D4 is coupled in an opposite direction of a body diode of the transistor Xfr to interrupt a current caused by the body diode of the transistor Xfr. The transistor Xrr is turned on to flow a weak current from the drain to the source so as to gradually increase a voltage at the X electrode X to the Vset voltage, and the transistor Xfr is turned on to flow the weak current from the drain to the source so as to gradually decrease the voltage at the X electrode X. The address driving circuit 412 includes a transistor Xb. The transistor Xb is coupled between a power source Vb for supplying a Vb voltage and the X electrode X, and two transistors are formed in a back-to-back manner to form the transistor Xb. In this case, when there is no body diode in the transistor Xb, the transistor Xb may be formed in one transistor.

The sustain discharge driving circuit 513 is coupled to a node N2 coupled to the X electrode X, and it has a similar configuration of the sustain discharge driving circuit 410 shown in FIG. 3. That is, the scan IC 411 is not provided to the driving circuit 510 coupled to the X electrode X. Accordingly, the transistor Xr1 having a source coupled to the node N2 and the transistor Xf2 having a drain coupled to the node N2 may respectively correspond to the transistors Sch and Sc1 of the scan IC 411 in the sustain discharge driving circuit 410. In addition, the transistor Xf1 corresponds to the transistor Y1, and the transistor Xr2 corresponds to the transistor Y2.

In FIG. 7, it has been described that the sustain discharge driving circuit 513 has a similar configuration to the sustain discharge driving circuit 410 shown in FIG. 3. However, to generate the driving waveform shown in FIG. 6C, since the X electrode is biased at the 0V voltage during the sustain period, it is not required to provide the sustain discharge driving circuit 513. In this case, it is required to connect a transistor for supplying the 0V voltage to the X electrode between the ground terminal and the X electrode X.

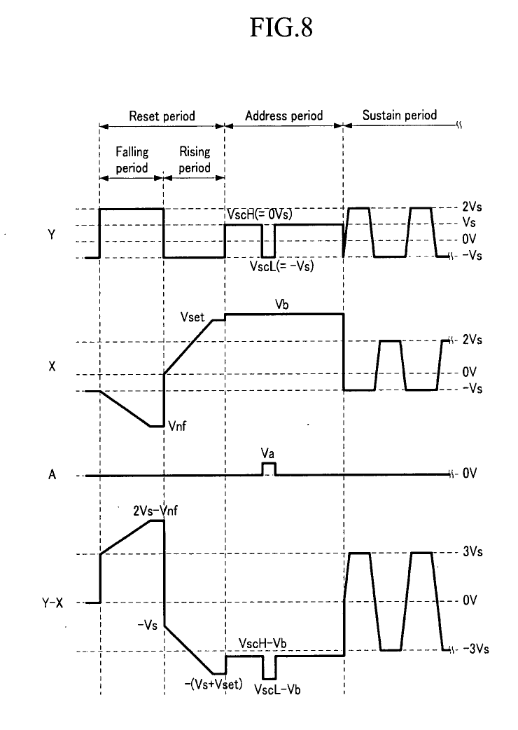

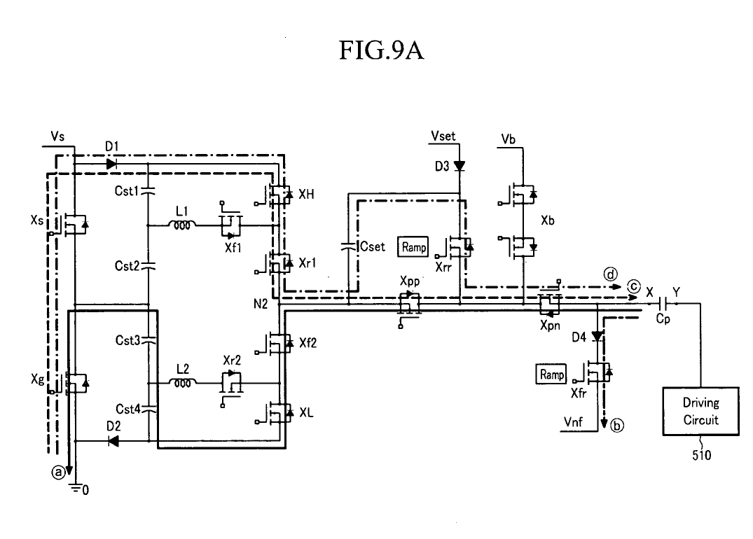

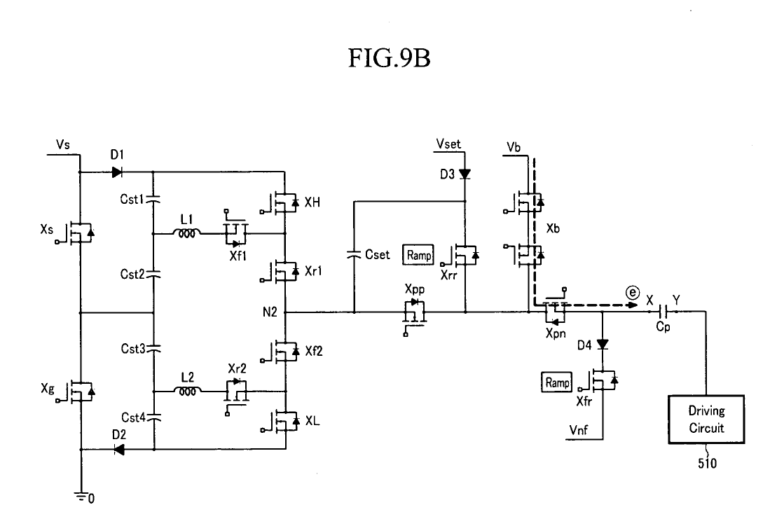

An operation for applying a reset waveform to the X electrode X by using the driving circuit 510 shown in FIG. 7 will be described with reference to FIG. 8 and FIG. 9A to FIG. 9B.

FIG. 8 shows a diagram representing driving waveforms of the plasma display according to another embodiment, and FIG. 9A and FIG. 9B respectively show diagrams representing an operation of the driving circuit 510 for generating the reset waveform shown in FIG. 8.

Referring to FIG. 8 and FIG. 9A, since transistors Xg, XL, Xf2, Xpp, and Xpn are turned on before a falling period of the reset period, the −Vs voltage is applied to the X electrode through a path [symbol] of the X electrode X of the panel capacitor Cp, a body diode of the transistor Xpn, the transistors Xpp, Xf2, and XL, the capacitors Cst4 and Cst3, the transistor Xg, and the ground terminal 0.

Subsequently, during the falling period of the reset period, while the 2Vs voltage is applied to the Y electrode Y through the path [symbol] shown in FIG. 5D, the transistors Xg, XL, Xf2, and Xpp are turned off, the transistor Xfr is turned on, and the voltage at the X electrode is gradually decreased from the −Vs voltage to the Vnf voltage through a path [symbol] of the X electrode of the panel capacitor Cp, the diode D4, the transistor Xfr, and the power source Vnf. Thereby, since a weak reset discharge is generated between the Y electrode Y and the X electrode X while decreasing the voltage at the X electrode X, (−) wall charges are formed on the Y electrode Y, and (+) wall charges are formed on the X electrode X and the A electrode A.

During a rising period of the reset period, while the −Vs voltage is applied to the Y electrode through the path [symbol] shown in FIG. 5H, the transistor Xfr is turned off, transistors XH, Xr, and Xpn are turned on, and the 0V voltage is applied to the X electrode through a path [symbol] of the ground terminal 0, body diodes of the transistors Xg and Xs, the diode D1, the transistors XH and Xr1, a body diode of the transistor Xpp, the transistor Xpn, and the X electrode X of the panel capacitor Cp. Subsequently, since the transistor Xrr is turned on, the voltage at the X electrode X is gradually increased from the 0V voltage to the Vset voltage through a path [symbol] of the ground terminal 0, the body diode of the transistors Xg and Xs, the diode D1, the transistors XH and Xr1, the capacitor Cset, the transistors Xrr and Xpn, and the X electrode X of the panel capacitor Cp. Thereby, the weak reset discharge is generated between the Y electrode Y and the X electrode X while decreasing the voltage at the X electrode X, and the (−) wall charge formed on the Y electrode Y and the (+) wall charges formed on the X electrode X and the A electrode A are eliminated to initialize the discharge cell. Generally, a voltage of −(Vs+Vset) is set close to a discharge firing voltage between the Y electrode Y and the X electrode X. Thereby, since a wall voltage between the Y electrode Y and the X electrode X become close to the 0V voltage, a misfire may be prevented during the sustain period in a cell in which no address discharge is generated during the address period.

During the address period, since the transistors XH, Xr1, and Xrr are turned off and the transistor Xb is turned on, the Vb voltage is applied to the X electrode X through a path [symbol] of the power source Vb, the transistors Xb and Xpn, and the X electrode X of the panel capacitor Cp. In this case, a VscL voltage (=−Vs) may be applied to the Y electrode Y through the path [symbol] shown in FIG. 5H to select a cell to be turned on, and a VscH voltage (=Vs) may be applied to the Y electrode to which the VscL voltage is not applied through a path of the power source Vs, the diode D1, the transistors YH, Yr1, and Sch, and the Y electrode of the panel capacitor Cp. In addition, a Va voltage is applied to the A electrode passing through the turn-on cell among the plurality of discharge cells formed by the Y electrode Y receiving the VscL voltage and the X electrode X receiving the Vb voltage.

During the sustain period, through the paths shown in FIG. 5A to FIG. 5H, the sustain pulse alternately having the 2Vs voltage and the −Vs voltage is applied to the X electrode X with an opposite phase of the sustain pulse applied to the Y electrode Y.

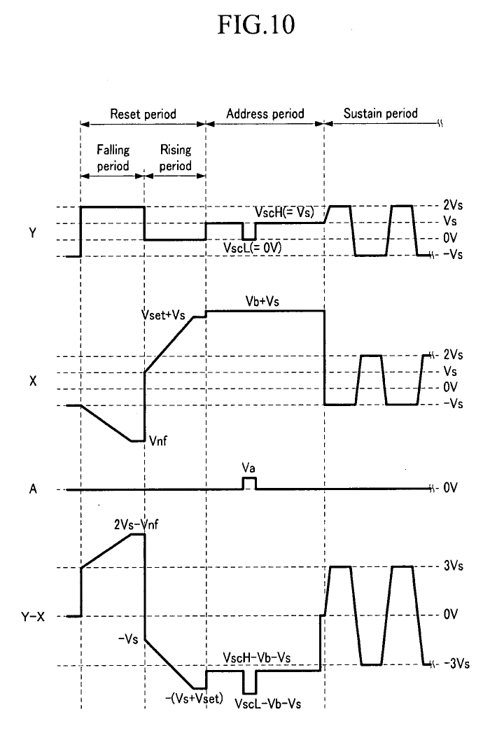

In addition, a voltage level applied to the X electrode X and the Y electrode Y during the rising period of the reset period and the address period may be changed, which will be described with reference to FIG. 10.

FIG. 10 shows a diagram representing driving waveforms of the plasma display according to another embodiment.

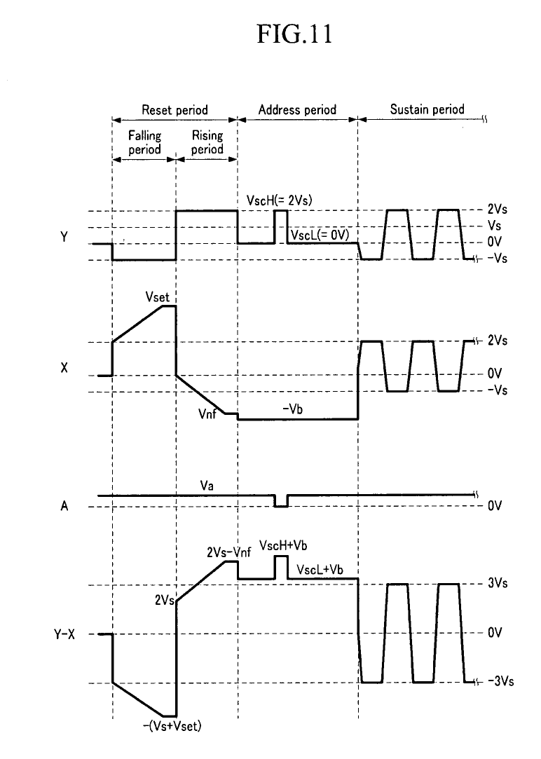

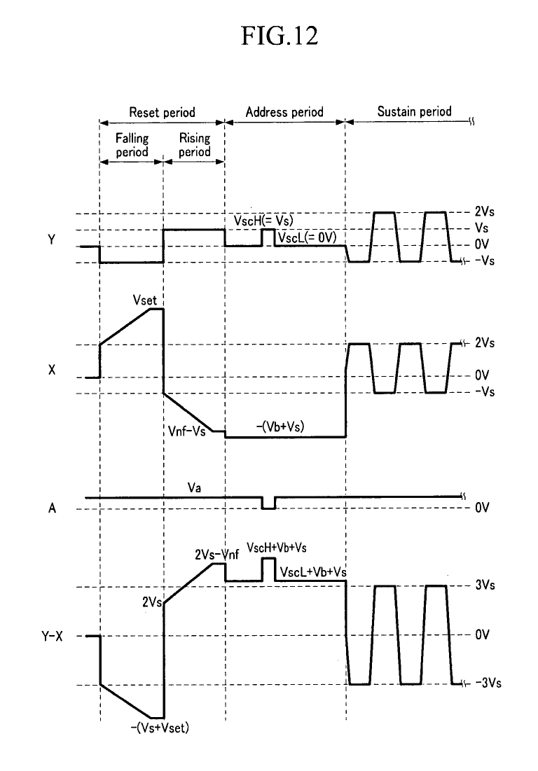

As shown in FIG. 10, the 0V voltage is applied to the Y electrode Y during the rising period of the reset period, and the voltage at the X electrode X may be gradually increased from the Vs voltage to a voltage of (Vset+Vs). In addition, during the address period, while a voltage of (Vb+Vs) is applied to the X electrode X, a VscL voltage (=0V) may be applied to the Y electrode Y of the turn-on cell. In this case, the voltage difference between the Y electrode Y and the X electrode X becomes the same as that of FIG. 8. In addition, as shown in driving waveforms in FIG. 11, wall charges having polarity that is opposite to the wall charges formed on the respective electrodes during the reset period of the driving waveforms in FIG. 8 may be formed. Further, as shown in driving waveforms in FIG. 12, wall charges having polarity that is opposite to the wall charges formed on the respective electrodes during the reset period of the driving waveforms in FIG. 10 may be formed.

FIG. 11 and FIG. 12 respectively show diagrams representing driving waveforms of the plasma display according to seventh and eighth exemplary embodiments of the present invention.

As shown in FIG. 11, during the rising period of the reset period, the −Vs voltage is applied to the Y electrode Y, and the voltage at the X electrode X is gradually increased from the 2Vs voltage to the Vset voltage. During the falling period of the reset period, the Vs voltage is applied to the Y electrode Y, and the voltage at the X electrode is gradually decreased from the 0V voltage to the Vnf voltage. Thereby, the (+) wall charges are formed on the Y electrode Y and the (−) wall charges are formed on the X electrode X and the A electrode A since the weak discharge is generated between the Y electrode Y and the X electrode X and between the Y electrode Y and the A electrode A when the voltage at the X electrode X increases, the (+) wall charges formed on the Y electrode Y and the (−) wall charges formed on the X electrode X and the A electrode A are eliminated since the weak discharge is generated between the Y electrode Y and the X electrode X and between the Y electrode Y and the A electrode A while the voltage at the X electrode X decreases, and the discharge cell is initialized.

Subsequently, during the address period, to select the cell to be turned on, a VscH voltage (=2Vs) and the 0V voltage are applied to the Y electrode Y and the A electrode A. In this case, the VscL voltage (=Vs) is applied to the Y electrode Y to which the VscH voltage is not applied, and the Vs voltage is applied to the A electrode A to which the 0V voltage is not applied. Thereby, the address discharge is generated between the Y electrode Y and the A electrode A by the 2Vs voltage and the wall voltage formed between the Y electrode Y and the A electrode A during the reset period. Therefore, the (−) wall charges are formed on the Y electrode Y and the (−) wall charges are formed on the X electrode X and the A electrode A.

During the sustain period, the sustain pulses applied to the Y electrode Y and the X electrode X are opposite to each other. In this case, since a high wall voltage of the X electrode X with respect to the Y electrode Y is formed in the cell in which the address discharge is generated during the address period, the −Vs voltage is firstly applied to the X electrode X.

As described, the driving waveform according some embodiments is the same as the driving waveform having the opposite polarity of the voltage applied to the Y electrode Y and the X electrode X in FIG. 8. Accordingly, since the voltage difference between the Y electrode Y and the X electrode X is the same as that of FIG. 8, the same operational effect as that of FIG. 8 may be performed.

In addition, the driving waveform according to the embodiment shown in FIG. 12 is the same as the driving waveform having the opposite polarity of the voltage applied to the Y electrode Y and the X electrode X in FIG. 10. In this case, since the voltage difference between the Y electrode Y and the X electrode X becomes the same as that of FIG. 10, the same operational effect as that of FIG. 10 may be performed.

As described above, according to the described embodiments of the present invention, since a transistor having a low voltage may be used in the sustain discharge driving circuit, the cost may be reduced.

While this invention has been described in connection with what is presently considered to be practical embodiments, it is to be understood that the invention is not limited to the disclosed embodiments, but, on the contrary, is intended to cover various modifications and equivalent arrangements.

What is claimed is:

1. A plasma display comprising:
a first electrode;
a second electrode configured to perform a display operation in cooperation with the first electrode;
a first transistor coupled to the first electrode;
a second transistor coupled to the first electrode;
a first capacitor configured to be charged with a first voltage and coupled to the first transistor;
a second capacitor configured to be charged with a second voltage and coupled between the first capacitor and a first node;
a third capacitor configured to be charged with a third voltage and coupled to the first node;
a fourth capacitor configured to be charged with a fourth voltage and coupled between the third capacitor and the second transistor;
a third transistor coupled between a first power source for supplying a fifth voltage and the first node;
a fourth transistor coupled between a second power source for supplying a sixth voltage and the first node, the sixth voltage being less than the fifth voltage;
a first path coupled between a node of the first and second capacitors and the first transistor configured to change a voltage at the first electrode;
a second path coupled between a node of the third and fourth capacitors and the second transistor configured to change the voltage at the first electrode; and
a reset driving circuit that is coupled to the second electrode and configured to gradually change a voltage at the second electrode during a reset period.

2. The plasma display of claim 1, wherein the reset driving circuit comprises:
a fifth transistor coupled between the second electrode and a third power source configured to supply a seventh voltage to gradually increase the voltage at the second electrode; and
a sixth transistor coupled between the second electrode and a fourth power source for supplying an eighth voltage to gradually decrease the voltage at the second electrode, wherein
the first and second transistors are configured to be selectively turned on during an address period.

3. The plasma display of claim 2, further comprising:
a first charging path coupled between the first power source and the first capacitor and configured to charge the first and second capacitors with the first and second voltages when the fourth transistor is turned on; and
a second charging path coupled between the second power source and the fourth capacitor and configured to charge the third and fourth capacitors with the third and fourth voltages.

4. The plasma display of claim 2, further comprising:
a seventh transistor coupled between the first capacitor and the first transistor; and
an eighth transistor coupled between the fourth capacitor and the second transistor.

5. The plasma display of claim 1, wherein
the first path comprises a first inductor and a ninth transistor coupled in series between the node of the first and second capacitors and the first transistor, and
the second path comprises a second inductor and a tenth transistor coupled in series between the node of the third and fourth capacitors and the second transistor.

6. The plasma display of claim 5, wherein the fifth voltage is a positive voltage and the sixth voltage is a ground voltage.

7. The plasma display of claim 5, wherein the fifth and sixth voltages are positive voltages.

8. The plasma display of claim 5, wherein the fifth voltage is a positive voltage, and the sixth voltage is a negative voltage.

9. The plasma display of claim 5, further comprising:
an eleventh transistor coupled to the second electrode;
a twelfth transistor coupled to the second electrode;
a fifth capacitor that is charged with the first voltage and is coupled to the eleventh transistor;
a sixth capacitor that is charged with the second voltage and is coupled between the fifth capacitor and a second node;
a seventh capacitor that is charged with the third voltage and is coupled to the second node;
an eighth capacitor that is charged with the fourth voltage and is coupled between the seventh capacitor and the twelfth transistor;
a thirteenth transistor coupled between the first power source and the second node;
a fourteenth transistor coupled between the second power source and the second node;
a third path coupled between a node of the fifth and sixth capacitors and the eleventh transistor to change the voltage at the second electrode; and
a fourth path coupled between a node of the seventh and eighth capacitors and the twelfth transistor to change the voltage at the second electrode.

10. The plasma display of claim 9, further comprising:
a fifteenth transistor coupled between the fifth capacitor and the eleventh transistor; and
a sixteenth transistor coupled between the eighth capacitor and the twelfth transistor.

11. A method of driving a plasma display comprising a plurality of first and second electrodes to perform a display operation, the method comprising:
during a reset period, gradually varying a voltage at the plurality of first electrodes while applying a first voltage to the plurality of second electrodes;
during an address period, sequentially applying a scan pulse to the plurality of second electrodes;
during a sustain period,
increasing a voltage at the plurality of second electrodes through a first capacitor coupled between a first node and the plurality of second electrodes while supplying a second voltage to the first node, and
further increasing the voltage at the plurality of second electrodes through a second capacitor coupled between the first node and the plurality of second electrodes while supplying the second voltage to the first node;
further increasing the voltage at the plurality of second electrodes through the second capacitor while supplying a third voltage that is higher than the second voltage to the first node;
decreasing the voltage at the plurality of second electrodes through the second capacitor while supplying the third voltage to the first node;
further decreasing the voltage at the plurality of second electrodes through the first capacitor while supplying the third voltage to the first node; and
further decreasing the voltage at the plurality of second electrodes through the first capacitor while supplying the second voltage to the first node.

12. The method of claim 11, further comprising, during the sustain period:
applying a fourth voltage to the plurality of second electrodes through the second capacitor and a third capacitor coupled between the second capacitor and the plurality of second electrodes while supplying the third voltage to the first node; and
applying a fifth voltage to the plurality of second electrodes through a fourth capacitor coupled to the first capacitor and between the first capacitor and the plurality of second electrodes while supplying the second voltage to the first node.

13. The method of claim 12, wherein
the applying of the fourth voltage to the plurality of second electrodes comprises charging respective voltages of the first and fourth capacitors through a first power source for supplying the third voltage, and
the applying of the fifth voltage to the plurality of second electrodes comprises charging respective voltages of the second and third capacitors through a second power source for supplying the second voltage.

14. The method of claim 12, wherein
the applying of the fourth voltage to the plurality of second electrodes comprises applying the fifth voltage to the plurality of first electrodes, and
the applying of the fifth voltage to the plurality of second electrodes comprises applying the fourth voltage to the plurality of first electrodes.

15. The method of claim 11, further comprising, during the reset period:
gradually increasing the voltage at the plurality of first electrodes through a first transistor coupled to the plurality of first electrodes to gradually increase the voltage at the plurality of first electrodes; and
gradually decreasing the voltage at the plurality of first electrodes through a second transistor coupled to the plurality of first electrodes to gradually decrease the voltage at the plurality of first electrodes.

16. The method of claim 12, wherein the voltage respectively charged in the first, second, third and fourth capacitors corresponds to a half of a difference between the second voltage and the third voltage.

17. A driver of a plasma display comprising a plurality of first electrodes and a plurality of second electrodes, the driver further comprising:
a scan integrated circuit comprising first and second input terminals and a plurality of first output terminals respectively coupled to the plurality of second electrodes, the scan integrated circuit configured to apply voltages at the first and second input terminals to the corresponding second electrode during an address period;
a first capacitor charged with a first voltage and coupled between the first input terminals;
a second capacitor charged with a second voltage and coupled between the first capacitor and a first node;
a third capacitor charged with a third voltage and coupled to the first node;
a fourth capacitor charged with a fourth voltage and coupled between the third capacitor and the second input terminal;
a first path coupled between a node of the first and second capacitors and the first input terminal of the scan integrated circuit, the first path configured to change a voltage at the plurality of first electrodes;
a second path coupled between a node of the third and fourth capacitors and the second input terminal of the scan integrated circuit, the second path configured to change the voltage at the plurality of first electrodes;
a first switching means configured to selectively apply a fifth voltage and a sixth voltage to the first node, the sixth voltage being less than the fifth voltage; and
a reset driving circuit coupled to the plurality of first electrodes configured to gradually change a voltage at the plurality of second electrodes during a reset period.

18. The driver of claim 17, wherein the reset driving circuit comprises:
a first transistor coupled between the plurality of first electrodes and a first power source configured to supply a seventh voltage to gradually increase the voltage at the plurality of first electrodes; and
a second transistor coupled between the plurality of first electrodes and a second power source configured to supply an eighth voltage to gradually decrease the voltage at the plurality of first electrodes.

19. The driver of claim 17, further comprising:
a third transistor coupled between the first capacitor and the first input terminal; and
a fourth transistor coupled between the fourth capacitor and the second input terminal.

20. The driver of claim 19, further comprising:
a fifth transistor coupled to the plurality of first electrodes;
a sixth transistor coupled to the plurality of first electrodes;
a seventh transistor coupled to the fifth transistor;
an eighth transistor coupled to the sixth transistor;
fifth and sixth capacitors respectively configured to be charged with the first and second voltages and coupled in series between the seventh transistor and a second node;
seventh and eighth capacitors respectively configured to be charged with the third and fourth voltages and coupled in series between the eighth transistor and the second node;
a third path coupled between a node of the fifth and sixth capacitors and the seventh transistor, the third path configured to change the voltage at the plurality of second electrodes;
a fourth path coupled between a node of the seventh and eighth capacitors and the eighth transistor, the fourth path configured to change the voltage at the plurality of second electrodes; and
a second switching means configured to selectively apply the fifth voltage and the sixth voltage to the second node.
